(19) United States
(12) Patent Application Publication
(10) Pub. No.: US 2024/0049700 A1
(43) Pub. Date: Feb. 15, 2024

(54) LIPID LAYER PRESERVATION

(71) Applicant: BIOSIP AB, Sturkö (SE)

(72) Inventor: Anne-Li SIGVARDSSON, Göteborg (SE)

(21) Appl. No.: 18/270,787

(22) PCT Filed: Dec. 16, 2021
(86) PCT No.: PCT/EP2021/086156

§ 371 Date: Jul. 3, 2023

(30) Foreign Application Priority Data
Jan. 4, 2021 (SE) 2130002-5
Aug. 18, 2021 (GB) 2111815.3

(51) Int. Cl. A01N 1/02

(52) U.S. Cl. CPC A01N 1/021

(57) ABSTRACT

The present invention relates to the use of Dextran 1 for the preservation of lipid layers, wherein the lipid layers are present in cells, micelles, or vesicles and wherein the cells, micelles, or vesicles are suspended in a solution, as well as a preservation solution for erythrocytes, a collection bag suitable for collecting blood, erythrocyte and/or thrombocyte, and a method of preserving lipid layers. The present invention relates to the use of Dextran 1 as a safe and effective lipid layer/membrane stabilizing agent.

### FIELD OF THE INVENTION

Preservation of lipid membranes is crucial in various clinical and research applications such as the preservation of cells in vitro and in prolonging the stability of lipid layer micelles or vesicles in solution. The present invention advantageously makes use of lipid membrane stabilizing properties of Dextran 1 for preserving lipid membranes, particularly cell membranes in blood and blood fractions such as erythrocytes and thrombocytes, and for non-cell lipid membranes such as micelles or vesicles, which can be used for administration of mRNA vaccines and other mRNA or miRNA treatments, and pharmaceuticals.

### BACKGROUND

### Prior Art—Larger Dextrans

Dextran 40, 60 and 70 (average molecular weights of 40, 60 and 70 kDa respectively) have a long clinical history for use in organ preservation and as plasma expanders. Their main use has been to function as oncotic molecules that prevent movement of water from the vasculature to the interstitial or cellular compartments. Dextran 40, 60 and 70 have also been shown to reduce adhesion of leukocytes to vascular endothelium and to prevent haemolysis.

However, problems that are known to occur on administration of these larger Dextran molecules include bleeding, anaphylactic reactions and renal injury. The bigger the Dextran molecule, the higher the risk of bleeding, which may be caused by binding to thrombocytes and blood clotting factors such as factor VIII, as well as plasma expansion leading to dilution of clotting factors. Therefore, use of Dextran 40, 60 or 70 is not acceptable in many clinical applications due to risk of complications.

### Prior Art—Blood Preservation

The preservation of blood is a particularly important area, since it is routinely donated and transplanted. Cellular blood components obtained from blood donors are used all over the world on a daily basis, with more than 85 million blood bags being administered to patients world-wide each year. The technology of how to preserve these components has largely remained the same over the last 40-50 years. The standard procedure is that donated blood is collected with Citrate-Phosphate-Dextrose (CPD) solution. The citrate serves as an anticoagulant as it binds the free calcium ions required for clotting mechanisms to be initiated, the phosphate is used for pH stabilisation and the dextrose serves as a metabolic substrate.

After retrieval, the blood is usually centrifuged and fractionated into buffy coat (leukocytes), which are usually discarded, and erythrocytes, thrombocytes and plasma, which are kept. The erythrocytes are generally preserved with Saline-Glucose-Mannitol (SAGM) solution, where mannitol is used as a membrane stabilizer. Plasma is frozen as it does not contain cells, whereas the thrombocyte and erythrocyte fractions most often are kept refrigerated as cell membranes are fragile when frozen.

Erythrocytes

The regulatorily acceptable stability time for erythrocytes varies between countries but is generally not more than 42 days. It is generally considered that erythrocytes more than 21 days old are aged erythrocytes. From in vitro studies it has been shown that reversible lesions occur around day 14 and irreversible lesions occur around day 28, although other studies claim that irreversible damage occurs around day 7. Erythrocyte storage lesions begin with membrane lesions and continue with depletion of ATP and 2,3-diphosphoglycerate (2,3-DPG). Erythrocytes with storage lesions are cleared in the spleen and thereby removed from the circulation. This removal results in reduced recovery of erythrocytes and reduced increase in Hb after transfusion. The reduced efficacy from the transfusion of aged erythrocytes results in wastage of blood products as more units of erythrocytes must be given to a patient to achieve the same effect.

In addition to reduced efficiency, there is some evidence that administration of stored erythrocytes can be harmful, as free haemoglobin and the breakdown products from free haemoglobin, i.e., hemin, are bound to the plasma proteins Hp and Hpx, as long as they are available. Once the stored Hp and Hpx are depleted, the remaining free Hb and Hemin can result in oxidative damage to tissues, especially to the vasculature, the spleen, the liver and the kidneys.

Accordingly, increasing the storage stability of erythrocytes would be a major and important medical advance.

The short life span of erythrocytes is important for all blood groups, but of course particularly so for rare blood types and for 0 negative blood.

Blood transfusions are also carried out in animal care, especially for cats, dogs, horses and rare zoo animals. As the donors are few, improved stability would facilitate the logistics of animal blood products, especially erythrocytes, saving lives as more animals could be saved with the donated blood.

The present invention aims to improve the storage stability of erythrocytes.

Thrombocytes

Another important part of human and animal blood is thrombocytes. These have an even more limited shelf-life of at most a week. Thrombocytes are preserved at room temperature in a gas permeable bag and with agitation to allow continuous gas exchange and to prevent aggregation. Usually they are resuspended with plasma for storage. The allowable storage time is 5-7 days. Improved stability could save lives. The present invention aims to improve the storage stability of thrombocytes.

Prior Art—Micelle/Vesicle Preservation

Phospholipids or other lipid membranes in the form of micelles or vesicles are used for administration of mRNA vaccines and other mRNA or miRNA treatment modalities. An example of such a vaccine of recent global importance is the Pfizer™ Covid-19 vaccine. The micelles or vesicles can be phospholipids or can be made of other molecules with hydrophobic and hydrophilic ends that create a micelle or vesicle structure that can encapsulate mRNA, miRNA or other molecules that need to enter the cells before the contents of the vesicles or micelles are released.

These vesicles or micelles are difficult to preserve and often are stored and transported in a frozen state, to be used shortly after thawing. Freezing by itself partly destroys the micelle or vesicle membranes and storage at liquid state aggravates the process.

Improving the storage stability of these micelle or vesicle structures would clearly be hugely beneficial to medical sciences, for example by making mRNA vaccines more widely available.

The present invention aims to improve the storage stability of these micelle and vesicle structures.

### SUMMARY OF THE INVENTION

According to a first aspect, the present invention relates to the use of Dextran 1 for the preservation of lipid layers, wherein the lipid layers are present in cells, micelles, or vesicles and wherein the cells, micelles, or vesicles are suspended in a solution.

According to a second aspect, the present invention relates to a preservation solution for erythrocytes, wherein the solution comprises: glucose; sodium chloride; adenine; and Dextran 1.

According to a third aspect, the present invention relates to a collection bag suitable for collecting blood, erythrocyte and/or thrombocyte, wherein the collection bag comprises Dextran 1 placed inside the collection bag.

According to a fourth aspect, the present invention relates to a method of preserving lipid layers, wherein the lipid layers are present in cells, micelles or vesicles, the method comprising the steps of: a) administering Dextran 1 to a suspension of the cells, micelles or vesicles; and (b) storing the suspension for at least 1 day at 1 to 40° C.

### Advantages of the Invention

The present invention relates to the use of Dextran 1 as a safe and effective lipid layer/membrane stabilizing agent. Previously Dextran 1 has been used as a hapten that is administered before administration of the longer dextran molecules 40, 60 and 70, to reduce the risk of anaphylactic reactions.

Dextran 1 has also been mentioned as a cryopreservative in WO2014/083169, i.e., used at sub-zero temperatures to reduce damage due to the cooling or thawing process. A cryopreservative reduces ice crystal formation and thereby preserves the structures. In other words, in WO2014/083169, Dextran 1 is being used for preservation of frozen, i.e. solid, cells.

In contrast in the present invention the cells, micelles, or vesicles are usually suspended in a solution, i.e., they are not frozen. Ice crystal formation is not induced in aqueous salt solutions at temperatures above 0° C. The present invention is generally concerned with preservation at normal temperatures above 0° C., rather than sub-zero temperatures, of, for example, 1 to 40° C., usually 4-8° C. for erythrocytes and 20-24° C. for thrombocytes. This is particularly the case in connection with the preservation of cells. Vesicles or micelles are preserved at these or other temperatures depending on their content and structure.

To the inventor's knowledge, Dextran 1 has not previously been used as a preservative specifically for lipid layers but has now been found to provide safe and effective products to be used for preservation of cells, cell membranes and/or other lipid layers including micelles and vesicles.

The present inventor has surprisingly discovered that Dextran 1 has lipid membrane stabilising properties that have previously only been seen with the larger Dextran molecules. This effect for the larger Dextran molecules has mainly been attributed to the size of the molecules. Advantageously, unlike the larger Dextran molecules, Dextran 1 is a safe molecule to administer to a patient with no known side effects and is renally extracted quickly. Dextran 1 does not result in the complications of anaphylactic reactions or bleeding and is easily cleared by the kidneys. Accordingly, Dextran 1 can safely be used in a broad range of clinical applications, including for the preservation of cells, especially blood products such as erythrocytes and thrombocytes and as a stabilizing agent for micelles or vesicles, which can be used in micelle or vesicle encapsulated products designed to enter the cellular compartment such as mRNA vaccines and other mRNA or miRNA products or for other lipid encapsulated pharmaceuticals or vaccines.

In accordance with the invention, the use of Dextran 1 for the preservation of lipid layers is typically in vitro.

### DETAILED DESCRIPTION

By Dextran 1 we mean Dextran with an average molecular weight of about 1 kDa. Dextran 1 is a well-known term in the art and is commercially available. It is defined as having a mean molecular weight of 850-1150 Da, and with ≤15% fraction of less than three glucose units and ≤20% fraction of more than nine glucose units, as per the European and US pharmacopeia.

Dextran 1 can be used as part of a preservation solution, but can also be used as a powder and dissolves easily in water.

In the invention the cells, micelles, or vesicles are suspended in a solution. By this we mean that the cells, micelles, or vesicles are suspended in a liquid, they are not frozen. The solution is generally an aqueous solution. It can be a preservation solution as discussed below, or can be blood.

Erythrocytes

As discussed above, Dextran 1 can be used to preserve cells, particularly the lipid membranes of cells. In a preferred embodiment, the cells are erythrocytes. As set out above, the storage stability of erythrocytes is a major issue, with erythrocytes more than 21 days old generally considered “aged”. The older the erythrocytes, the less effective they are, and the more potentially harmful they can be, as set out above in the background section.

In the present invention, the use of Dextran 1 to increase the storage stability of erythrocytes is a major and important medical advance.

The standard process for preparation and preservation of erythrocytes can be found at: http://www.optimalblooduse.eu/content/64-outline-blood-component-preparation-and-composition. It is summarised as follows.

1. 450 ml blood is drawn and immunodepleted through use of a leucocyte filter from a blood donor into a bag with 63 ml of CPD solution (see below).

2. The blood is processed through centrifugation or other means to separate the different fractions, and the erythrocyte fraction is suspended in 100 ml of SAGM solution, as below. The final volume in an erythrocyte bag, which includes the 100 ml SAGM solution, varies between about 200 to 350 ml or more commonly about 280 ml, usually with a haematocrit of about 54-60%. The same amount of SAGM is used independently of the actual volume of the erythrocytes.

As the erythrocyte fraction is mainly cells and contains only about 20 ml of plasma, about 4 ml of the CPD solution remains within the erythrocyte suspension. Hence the contribution to final composition of the stored erythrocytes is small.

TABLE 1
CPD solution.

| | | Molecular | |
|---|---|---|---|
| | | weight | |
| Component | g/l* | (g/mol) | mM |
| Citric acid monohydrate | 3.27 | 210.1 | 15.56 |
| Sodium citrate dihydrate | 26.30 | 294.1 | 89.43 |
| Sodium dihydrogen phosphate | 2.51 | 156.01 | 16.09 |
| dihydrate | | | |
| Dextrose monohydrate | 25.5 | 198.17 | 128.68 |

*Weight per liter composition according to D'Amici et al 2012 (Red blood cell storage in SAGM and AS3: a comparison through the membrane two-dimensional electrophoresis proteome Blood Transfus. 2012 May; 10(Suppl 2): s46-s54. Gian Maria D'Amici, Cristiana Mirasole, Angelo D'Alessandro, Tatsuro Yoshida, Larry J. Dumont, and Lello Zolla).

An alternative preservation solution in clinical use is AS3. This solution is used together with a CP2D solution instead of the CPD solution.

TABLE 2
CP2D solution.

| | | Molecular | |
|---|---|---|---|
| | | weight | |
| Component | g/l* | (g/mol) | mM |
| Citric acid monohydrate | 3.27 | 210.1 | 15.56 |
| Sodium citrate dihydrate | 26.30 | 294.1 | 89.43 |
| Monobasic sodium phosphate | 2.22 | 137.99 | 16.09 |
| (monohydrate) | | | |
| Dextrose anhydrous | 46.40 | 180.16 | 258 |

*Weight per liter composition according to D'Amici et al 2012.

Dextran 1 can be added to the CPD or CP2D solution, i.e., a preservation solution that comprises citric acid, sodium citrate, sodium phosphate and dextrose. It would usually be added in an amount of 0.5 to 10 g of Dextran 1 per 100 ml or 1.25 to 2.5 g of Dextran 1 per 100 ml solution.

TABLE 3
SAGM, 100 ml of solution is used to mix with the erythrocytes
fraction from about 450 ml donated blood.

| | | Molecular | |
|---|---|---|---|
| | | weight | |
| Component | g/l* | (g/mol) | mM |
| Glucose monohydrate | 9 | 198.17 | 45.42 |
| Sodium Chloride | 8.77 | 58.44 | 150.07 |
| Adenine | 0.169 | 135.13 | 1.25 |
| mannitol | 5.25 | 182.17 | 28.82 |

*Weight per liter composition according to D'Amici et al 2012.

TABLE 4
AS3, 100 ml of solution is used to mix with the erythrocytes
fraction from about 450 ml donated blood.

| | | Molecular | |
|---|---|---|---|
| | | weight | |
| Component | g/l* | (g/mol) | mM |
| Glucose anhydrous | 10.00 | 180.16 | 55.51 |
| Sodium Chloride | 4.10 | 58.44 | 70.16 |
| Adenine | 0.30 | 135.13 | 2.22 |
| Citric acid monohydrate | 0.42 | 210.1 | 2.00 |
| Sodium citrate dihydrate | 5.88 | 294.1 | 19.99 |
| Monobasic sodium phosphate | 2.76 | 137.99 | 20.00 |
| (monohydrate) | | | |

*Weight per liter composition according to D'Amici et al 2012.

CPD, CP2D, SAGM and AS3 solutions are crystalloid aqueous solutions. Variations of these solutions and alternative solutions might also be basis for supplementing the solution with Dextran 1 to improve the lipid layer stability in a suspension comprising lipid membranes.

Dextran 1 can advantageously be used to fully or partly replace the mannitol part of the SAGM solution (which would then become a SAGD solution), resulting in improvements in the storage stability of the erythrocytes. Accordingly, the invention relates to the use of Dextran 1 in a preservation solution comprising: glucose; sodium chloride; adenine; and Dextran 1. Alternatively it can be used as an addition to the AS3 solution or to the CPD, CP2D or to an alternative crystalloid aqueous solution.

A further advantage of Dextran 1 in this context is that, as well as being a membrane stabiliser, Dextran 1 is also an energy substrate.

Accordingly, when using Dextran 1, the glucose concentration of a traditional CPD, CP2D, SAGM, AS3 or alternative similar solution may be reduced, to avoid hyperglycaemia during preservation and at transfusion. A physiological pH may further improve the preservation of the erythrocytes, and lead to fewer storage lesions. Reducing the storage lesions on erythrocytes is expected to improve the safety of blood transfusions and/or prolong the time that the erythrocytes can safely be stored.

The procedure used today is to add 100 ml of the SAGM or AS3 solution to erythrocytes from one blood donor giving about 450 ml of “blood” to use in a transfusion. To maintain the standard procedure, the same can be done with the SAGD solution or an AS3 dextran 1 solution, resulting in different actual concentrations in the final solution depending on the number of erythrocytes or rather fluid volume in the bag. Normally the total volume of the erythrocyte fraction will be about 250-320 ml, with the main difference in the final volume being the number or volume of donated erythrocytes and not the volume of fluid. As the erythrocytes are suspended rather than dissolved in the solution, the concentration of the fluid surrounding the cells is independent of the actual volume of erythrocytes. Hence, preferably the preservation solution, which can be a SAGD solution or an AS3 dextran 1 solution or an alternative aqueous crystalloid solution, should comprise 0.5 to 10 g, or 1 to 5 g of Dextran 1 per 100 ml, or more preferably 1 to 3 g of Dextran 1 per 100 ml or 1.25 to 2.5 g of Dextran 1 per 100 ml solution. This would typically be used for each erythrocyte bag of standard size.

As the Dextran 1 might provide additional energy substrate for the erythrocytes during preservation, the glucose concentration may be reduced or maintained at about 45 mM. For example, the glucose concentration can be between 10-45 mM or preferably, between 22.5-45 mM or 15-30 mM. Reduction of glucose might reduce the glycosylation of the erythrocytes that occurs under hyperglycaemic conditions. Even without reducing the glucose levels, the Dextran 1 could be metabolised as glucose during the storage period, providing additional longer lasting energy substrates preventing loss of ATP and/or 2,3-DPG from the erythrocytes.

Dextran 1 may also function as a free oxygen radical scavenger during preservation of the erythrocytes, preventing oxidative damage to the cells. The higher molecular weight of Dextran 1 compared to Mannitol means that a higher weight/volume could be used without increasing the osmolality. This might further increase the protective effect to the cell membranes, micelles or vesicles.

Control of pH could be maintained with any physiologically acceptable buffer, such as for example TRIS, MOPS, phosphate, HEPES, glycine or histidine. The appropriate pH could be set to pH 3-8, or preferably 6-7.8 or more preferably to 6.5-7.6 or 6.8-7.7 or 7-7.4 or 6.8-7.2 as measured at room temperature of about 20-22° C.

TABLE 5
Examples of compositions of a SAGD solution.

| Component | g/l | g/l | g/l |
|---|---|---|---|
| Glucose | 0-15 | 4.5-10 | 9 |
| monohydrate | | | |
| Sodium Chloride | 0-20 | 5-10 | 8.77 |
| Adenine | 0-0.500 | 0.1-0.3 | 0.169 |
| Dextran 1 | 1-100 | 5-50 | 12.5-25 |
| mannitol | 0-5.25 | 0-2 | 0 |
| TRIS | 0-0.5 | 0-0.242 | 0.242 |

Accordingly, the preservation solution can be an aqueous solution that, in addition to water, consists essentially of: 0 to 15, preferably 4.5 to 10, most preferably about 9 g/l glucose monohydrate; 0 to 20, preferably 5 to 10, most preferably about 8.77 g/l sodium chloride; 0 to 0.500, preferably 0.1 to 0.3 g/l, most preferably about 0.169 g/l adenine; 1 to 100, preferably 5 to 50, most preferably 12.5 to 25 g/l Dextran 1, optionally 0 to 5.25, 0 to 2, g/l mannitol most preferably no mannitol, and optionally a buffer selected from TRIS, phosphate, MOPS, HEPES, glycine or histidine, preferably wherein the buffer is TRIS in an amount of 0 to 0.5, preferably 0 to 0.242, most preferably about 0.242 g/1.

The SAGD solution may comprise additional components to preserve the erythrocytes or more specifically preserve the cell membrane structure of the erythrocytes and/or provide metabolic support to the erythrocytes.

The proposed compositions provide improved preservation of the erythrocytes in terms of improved membrane preservation, reduced haemolysis and/or improved metabolism compared to use of standard SAGM solution. The use of SAGD compared to SAGM may also improve blood recipient outcomes in terms of cardiovascular, renal and liver complications or in terms of survival and reduced morbidity for example resulting in reduced ICU or hospital stay.

The use of SAGD compared to SAGM may also prolong the safe period of use of preserved erythrocytes, simplifying logistics at blood banks and improve accessibility of rare blood groups, without having to freeze preserve the erythrocytes which results in additional lesions.

As an alternative, the Dextran 1 may be administered to the erythrocytes in the CPD, or any other solution used for processing the blood or can be administered as a separate solution or powder during any of the process steps of the erythrocytes.

In another embodiment the same principle is used for animal blood with the volumes of the SAGD solution adjusted to the donated blood volume. Use of this invention on animal blood, can improve accessibility of rare animal blood as required for example for cats, dogs, horses and rare zoo or national park animals.

Thrombocyte Preservation

Dextran 1 can also be used to improve and/or prolong preservation of thrombocytes with similar benefits. The important factor is to add Dextran 1 to the thrombocyte preparation obtained from a blood donor, either as solution or as a powder. Thrombocytes from 4-6 blood donors are usually mixed together in a single bag to make up a transfusion unit of 200-300 ml of thrombocyte suspension. If apheresis is used for collection of thrombocytes it usually comprises thrombocytes from a single donor with a total volume closer to 200 ml. For example the amount of Dextran 1, either included in the bag as a powder or added as a concentrated Dextran 1 solution, is 1-50 g of Dextran 1, or preferably 2.5-25 g of Dextran 1, or more preferably 2.5-10 g of Dextran 1.

Collection Bag

In a further embodiment, the Dextran 1 is not added in a solution, but is instead placed inside the blood, erythrocyte and/or thrombocyte collection bag. In such case the bag might comprise 0.2 to 100 g or 1 to 50 g or 1 to 10 g of Dextran 1, depending on which bag size and blood product it is, with the aim of generating similar concentrations of Dextran 1 in the final cell suspension as exemplified when the Dextran 1 is added via a solution. The Dextran 1 is added prior to the collection, so that the blood, erythrocyte and/or thrombocyte membranes are stabilised immediately on being collected and mixed with the Dextran 1.

To achieve thrombocyte as well as erythrocyte preservation with Dextran 1, the Dextran 1, might be included already in the collection solution, as an alternative to the CPD, CP2D or alternative solution or the Dextran 1 components could be present already in the collection bag as powder. For example, a blood bag collecting about 450 ml blood from a donor may comprise 1-100 g of Dextran 1, or more preferably 1-50 g or 5-15 g of Dextran 1.

Preservation of Whole Blood

Dextran 1 can equally be used to preserve blood cells in whole blood, either when used for autologous transfusions or as a preservative of suctioned blood during surgery or during acute bleeding. Dextran 1 may also replace Mannitol in priming solutions for extra corporeal circulation (ECC). Dextran 1 can further be used as a supplement to the blood during haemodialysis to prevent haemolysis and to protect the other cells of the blood and vascular endothelium and to prevent leukocyte activation. For example, a Dextran 1 concentration of 0.5-100 g/l of blood can be used, more preferably 1-50 g/l blood or 1-10 g/l blood or 2-5 g/l blood.

Today it is common to use crystalloid solutions like Ringer's lactate or Ringer's acetate with or without mannitol to prime cardiopulmonary bypass circuits. Alternatively colloid solution are used as for example PrimECC®. PrimECC® is a solution based on Ringer's lactate supplemented with Dextran 40 and Dextran 1. According to the present invention, for certain properties of the PrimECC® solution such as prevention of haemolysis could be achieved without using the Dextran 40 components and thereby risks of bleeding and anaphylactic reaction would be removed. However, Dextran 1, could not replace the oncotic effect which is the primary reason for use of a colloid priming solution. As an example a solution comprising Ringer's lactate or Ringer's acetate can be supplemented with 5-50 g/l of Dextran 1 or more preferably with 5-20 g/l of Dextran 1.

During haemodialysis, an aqueous solution comprising glucose, electrolytes and buffers is generally in indirect contact with the patient's blood though a dialysis filter. Small molecules can pass the membrane of the dialysis filter, while larger molecules like cells and plasma proteins remain within the blood circulation. Haemodialysis is used to normalise blood composition when the kidneys cannot provide sufficient effect to do this. The composition of a dialysis solution is usually optimized for the individual patient's need. This is done through mixing of different ion composition solutions as well as pH adjusting solutions. During dialysis mainly water and urea are removed from the blood and electrolyte concentrations are normalised. The process involves stress to the erythrocytes and thrombocytes in the patient's blood as they are continuously in contact with artificial surfaces. To improve stabilization of the erythrocytes and thrombocytes during haemodialysis a pre-injection or preferably continuous infusion of Dextran 1 can be administered to the patient. The Dextran 1 will either be metabolised into glucose or to a larger extent will be removed through the dialysis filter. To avoid the situation where all Dextran 1 is immediately removed, it can also be added to the dialysis solution to prevent the osmotic forces from immediately removing the Dextran 1 from the circulation to the dialysate. Preferably equimolar concentrations are used in plasma as in the dialysate solution. Alternatively, the Dextran 1 is only administered with the dialysis solution and will pass from there, over the dialysis membrane into plasma until equivalence in free Dextran 1 is achieved between plasma and dialysate. The volume of dialysis solution is generally between 1.5-2.5 litres depending partly on the size of the patient.

For example, a Dextran 1 concentration of 0.5-100 g/l of blood can be used, more preferably 1-50 g/l blood or 1-10 g/l blood or 2-5 g/l blood.

Alternatively, if the Dextran 1 is supplemented into the dialysis solution it can comprise 10-200 g/l of solution, more preferably 10-50 g/l of the solution.

Micelles and Vesicles

In addition to being useful for cells, the lipid layer protective effect of Dextran 1 can be used to preserve lipid layers such as micelles or vesicles that can be of single (micelle) or double-layer (vesicle) nature. The lipid layers can be composed of phospholipids or other lipids or combination of lipids or combination of lipids and proteins and/or other substances, that can form micelles or vesicles.

The lipid layers protected by addition of Dextran 1 can contain inside the layer structure mRNA as for example used in mRNA vaccines or for other mRNA or miRNA treatments. An example is the Pfizer™ or Moderna™ Covid 19 vaccination.

It can also be used for preservation of other pharmaceuticals encapsulated by a lipid layer that promotes cellular uptake, such as pharmaceuticals acting inside the cell cytoplasm or nucleus, such as transcription factors, transcription affecting drugs and ATP.

As such vaccines or treatment micelles or vesicles are given in small volumes, a high concentration of Dextran 1 may be used for the preservation. For example, a concentration of 0.1-500 g/l of a suspension can be used, preferably 10-250 g/l or 50-100 g/l.

The addition of Dextran 1 can improve stability of lipid single or bilayers and thereby improve their integrity and/or prolong storage times for the suspended preparations.

Accordingly, the preservation of lipid layer encapsulated mRNA, miRNA or pharmaceuticals can be administered during in situ or ex vivo isolated perfusion to ensure that the components reach the right area and/or cell type.

The vesicles or micelles protected by Dextran 1 may be used to protect the vasculature from oxidative effect during perfusion of an organ ex vivo using an artificial oxygen carrier encapsulated within the vesicle or micelle.

Method

One aspect of the invention relates to a method of preserving lipid layers, wherein the lipid layers are present in cells, cell membranes, micelles or vesicles composed of phospholipids or other lipids or combinations of lipid molecules, through use of Dextran 1 for membrane, micelle or vesicle stabilization.

The method of using Dextran 1 for stabilization of cells, cell membranes, micelles or vesicles comprises a step of administering Dextran 1 to a suspension or solution comprising the cells, cell membranes, micelles or vesicles to be protected by the Dextran 1. The Dextran 1 can bind to or interact with the cells, cell membranes, vesicles or micelles to stabilize them. If the suspension comprises cells or otherwise metabolically active components, the Dextran 1 may be used in the method as a metabolic substrate. Furthermore, the Dextran 1 used in the present method may provide an oxidative scavenging effect that further protects the cells, cell membranes, micelles or vesicles to be protected.

The method also comprises a step of storing the suspension or solution for at least 1 day at 1 to 40° C., or preferably at least 1 week at 1-40° C., or more preferably at least 1 month at 1-40° C. Longer preservation times, i.e., more than 1 week are preferably done at 2-8° C. Dextran 1 in the suspension or solution stabilizes the lipid layers of the cells, cell membranes, micelles or vesicles during the step of storing. Time and temperature for the step of storing can be selected based on the cells, cell membranes, micelles, or vesicles being stored. The time of storage can be, for example, at least 1, 2, 3, 4, 5, 6, 7, 8, 9, 10, 11, 12, or more weeks for erythrocytes, e.g. 1-12 weeks, 2-12 weeks, 3-12 weeks, 4-12 weeks, 5-12 weeks, 6-12 weeks, 7-12 weeks, 8-12 weeks, 9-12 weeks, 10-12 weeks, or 11-12 weeks. The time of storage also can be, for example, at least 2, 3, 4, 5, 6, 7, 8, 9, 10, 11, 12, 13, 14 or more days for thrombocytes, e.g. 2-14 days, 3-14 days, 4-14 days, 5-14 days, 6-14 days, 7-14 days, 8-14 days, 9-14 days, 10-14 days, 11-14 days, 12-14 days, or 13-14 days. The temperature can be, for example, 4-8° C. for erythrocytes, or 20-24° C. for thrombocytes. Other times and/or temperatures may also be used for these cells, as well as for other cells and for cell membranes, micelles and vesicles.

Following the step of storing, the cells, cell membranes, micelles or vesicles can be used, for example, for treatment or vaccination of a human or animal in need of the cells, cell membranes, micelles, or vesicles.

The concentration of the Dextran 1 to be used in the method depends on the application according to the description above. For preservation of erythrocytes the method comprises administration of about 0.5-50 g or 1-10 g or 1-5 g of Dextran 1 per unit of erythrocytes obtained from each donor giving about 450 ml of blood.

### EXAMPLES

### Example 1

The effect on preservation of erythrocytes was investigated with heparinised porcine whole blood. Suspensions of 50 ml of the whole blood in tubes were mixed with an aqueous solution of Dextran 1, providing a concentration of 0, 5 or 10 g/l of Dextran 1 to the blood suspensions. The tubes were stored refrigerated in between measurements. At the time of measurement, the tubes were centrifuged, and the haemolysis was measured using the HemoCue® Plasma Low Hb system, in the samples. Two tubes were used for each concentration and each sample was measured twice except in the last measurement, where a single measurement was used. The samples were kept and analysed at 1, 2, 3, 4 and 6 weeks. At 6 weeks the samples were analysed for glucose and lactate to evaluate if there was ongoing metabolism.

TABLE 6
Mean level of haemolysis for the two
samples and double measurements.

| | | | | | |
|---|---|---|---|---|---|
| Week | 1 | 2 | 3 | 4 | 6 |

| | | | | | | |
|---|---|---|---|---|---|---|
| control 0 | g/l | 4.25 | 7.95 | 10.18 | 18.60 | 23.90 |
| 5 | g/l | 3.05 | 5.95 | 7.05 | 10.88 | 12.65 |
| 10 | g/l | 1.43 | 2.80 | 3.20 | 5.38 | 7.45 |

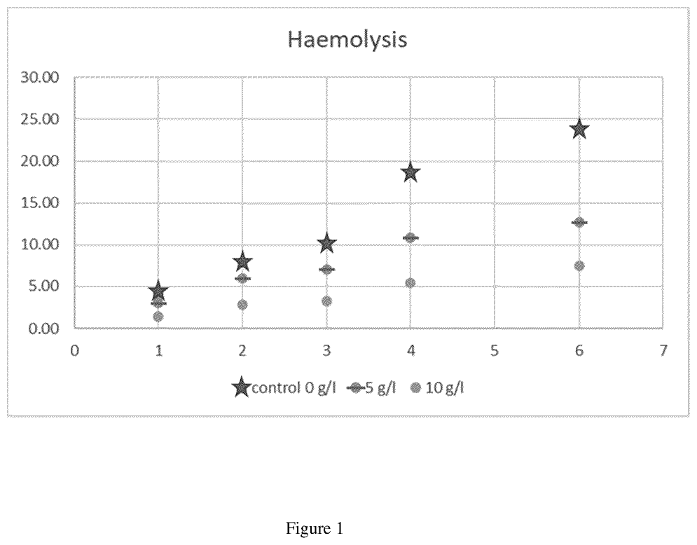

As can be seen in FIG. 1, which is a graph of haemolysis versus time (weeks), a clear dose response relationship is evident for the two concentrations of Dextran 1 used and both concentrations demonstrably reduce haemolysis compared to the control preparation without any Dextran 1.

As above, at 6 weeks the samples were analysed for glucose and lactate to evaluate if there was ongoing metabolism. The results are shown in Table 7.

TABLE 7
Mean measurement result of glucose and lactate
in the preparations after centrifugation.

| Sample | Glucose (mmol/l) | Lactate (mmol/l) |
|---|---|---|
| Control | 0 | 4.2 |
| 5 g/l Dextran 1 | 0.1 | 6.0 |
| 10 g/l Dextran 1 | 0.8 | 6.7 |

The results show that the samples with Dextran 1 still had measurable concentrations of glucose in the preparation and higher lactate content after 6 weeks, indicating improved accessibility of glucose from degradation of Dextran 1 and increased maintained metabolic activity.

### Example 2

Nine different versions of erythrocyte preservation solutions according to Table 8, below were evaluated. The erythrocytes were obtained through collection in CPD solution of about 500 ml porcine blood. The CPD blood was divided in 9 tubes, each with 50 ml. After centrifugation and removal of buffy coat, plasma and thrombocytes, the remaining erythrocytes were resuspended with 11 ml of one each of the solution compositions of Table 8.

The suspensions were moved to suitable test tubes and immediate haemolysis and blood gas are measured to investigate free haemoglobin, glucose, and pH in the respective solution.

The tubes were stored refrigerated and were analysed for haemolysis, glucose and pH every second week for 8 weeks.

TABLE 8
Solutions used for further optimisation of an erythrocyte preservation solution, the
solutions being aqueous, with the components given in g/100 ml, and the solutions
being used to suspend erythrocytes.

| | Sol 1 | Sol 2 | Sol 3 | Sol 4 | Sol 5 | Sol 6 | Sol 7 | Sol 8 | Sol 9 |
|---|---|---|---|---|---|---|---|---|---|
| Dextran 1 | 0 | 1.25 | 2.5 | 1.25 | 2.25 | 1.25 | 2.5 | 1.25 | 2.5 |
| Glucose × | 0.9 | 0.9 | 0.9 | 0.45 | 0.45 | 0.9 | 0.9 | 0.45 | 0.45 |
| H2O | | | | | | | | | |
| NaCl | 0.87 | 0.87 | 0.87 | 0.87 | 0.87 | 0.87 | 0.87 | 0.87 | 0.87 |
| Adenine | 0.0169 | 0.0169 | 0.0169 | 0.0169 | 0.0169 | 0.0169 | 0.0169 | 0.0169 | 0.0169 |
| mannitol | 0.525 | 0 | 0 | 0 | 0 | 0 | 0 | 0 | 0 |
| TRIS | 0 | 0 | 0 | 0 | 0 | 0.0242 | 0.0242 | 0.0242 | 0.0242 |
| (pH 7.4) | | | | | | | | | |

The results presented in the table 9, indicates that all Dextran 1 containing solutions reduced haemolysis compared to control solution based on mannitol. The results presented are the mean of two different bloods representing the two porcine blood types 0 and A. Analysis was performed with Hemcue® Plasma Low/Hb system.

TABLE 9
mean measurement of hemolysis

| Free | T = 0 | T = 2 | T = 4 | T = 6 | T = 8 |
|---|---|---|---|---|---|
| heme g/l | weeks | weeks | weeks | weeks | weeks |
| Sol 1 | 0.1 | 2.0 | 8.5 | 16.0 | 20.3* |
| (control) | | | | | |
| Sol 2 | 0.2 | 1.1 | 3.0 | 5.0 | 12.1 |
| Sol 3 | 0.1 | 1.8 | 2.6 | 4.1 | 7.5 |
| Sol 4 | 0.2 | 1.6 | 2.4 | 4.9 | 10.0 |
| Sol 5 | 0.1 | 1.9 | 2.8 | 5.6 | 9.9 |
| Sol 6 | 0.1 | 1.3 | 2.6 | 4.7 | 8.4 |
| Sol 7 | 0.2 | 1.5 | 2.5 | 3.9 | 7.2 |
| Sol 8 | 0.2 | 1.2 | 2.3 | 5.8 | 11.3 |
| Sol 9 | 0.2 | 1.9 | 2.9 | 4.4 | 8.8 |

*Includes one value above measurable range of 30 mg/ml

The results in table 10 indicate that all Dextran 1 solutions provided better pH stability of the stored erythrocytes over time than the control solution.

TABLE 10
mean measurement of pH

| | T = 0 | T = 2 | T = 4 | T = 6 | T = 8 |
|---|---|---|---|---|---|
| pH | weeks | weeks | weeks | weeks | weeks |
| Sol 1 | 7.00 | 6.67 | 6.53 | 6.48* | 6.30** |
| (control) | | | | | |
| Sol 2 | 7.02 | 6.67 | 6.59 | 6.57 | 6.48 |
| Sol 3 | 7.01 | 6.77 | 6.74 | 6.76 | 6.80 |
| Sol 4 | 7.01 | 6.78 | 6.75 | 6.76 | 6.79 |
| Sol 5 | 7.01 | 6.78 | 6.75 | 6.67 | 6.63 |
| Sol 6 | 7.04 | 6.81 | 6.77 | 6.79 | 6.81 |
| Sol 7 | 7.03 | 6.79 | 6.75 | 6.77 | 6.79 |
| Sol 8 | 7.05 | 6.80 | 6.78 | 6.69 | 6.66 |
| Sol 9 | 7.01 | 6.69 | 6.67 | 6.68 | 6.71 |

*Includes one value below the measuring range of 6.3
**Includes two values below the measuring range of 6.3

The glucose levels differed initially as expected depending on the amount provided by the respective solution. All test solutions including Dextran 1, maintained a higher glucose concentration over 8 weeks of preservation of erythrocytes compared to the control.

TABLE 11
mean measurement of glucose

| Glucose | T = 0 | T = 2 | T = 4 | T = 6 | T = 8 |
|---|---|---|---|---|---|
| mmol/l | weeks | weeks | weeks | weeks | weeks |
| Sol 1 | 33 | 30 | 20 | 13 | 8 |
| (control) | | | | | |
| Sol 2 | 35 | 31 | 30 | 27 | 23 |
| Sol 3 | 36 | 36 | 38 | 37 | 36 |
| Sol 4 | 27 | 26 | 28 | 28 | 26 |
| Sol 5 | 29 | 28 | 31 | 26 | 23 |
| Sol 6 | 34 | 33 | 35 | 34 | 32 |
| Sol 7 | 36 | 34 | 35 | 36 | 33 |
| Sol 8 | 27 | 26 | 27 | 22 | 20 |
| Sol 9 | 28 | 26 | 27 | 28 | 25 |

### CLAUSES

1. A preservation solution or powder comprising Dextran 1, for preservation of lipid layer structures, wherein the lipid layers are cells, cell membranes, phospholipid membranes or other lipid layers used for encapsulation of miRNA, mRNA or pharmaceuticals used for treatment or vaccination of human or animals.

2. A preservation solution or powder according to clause 1, wherein the preserved cells are erythrocytes, and the amount of Dextran 1 is between 0.5 and 10 g per each bag of erythrocytes obtained from a blood donor giving about 450 ml of blood.

3. A preservation solution according to clause 1 or clause 2, wherein the Dextran 1 is comprised in a saline, adenine and glucose solution added to the erythrocytes prepared from a blood donor.

4. A preservation solution according to clause 3, wherein the saline, adenine and glucose and Dextran 1 solution further comprises a buffer.

5. A preservation solution according to clause 4, wherein the buffered saline, adenine and glucose and Dextran 1 solution has a pH of between 6.8-7.6.

6. A preservation solution according to clause 6, wherein the buffer is selected from TRIS, phosphate, MOPS, HEPES, glycine or histidine

7. A method to preserve cells, cell membranes, micelles or vesicles with administration of Dextran 1 to a solution or suspension of the cells, cell membranes, micelles or vesicles to stabilize the lipid layer structure.

8. A method according to clause 6, wherein the cells to preserve are erythrocytes and the concentration of Dextran 1 administered is 0.5-50 g of Dextran 1, per unit of erythrocytes obtained from a blood donor giving about 450 ml blood.

1. A method for the preservation of lipid layers above 0° C., wherein the lipid layers are present in cells, micelles, or vesicles, comprising administering Dextran 1 to a solution or suspension of the cells, micelles, or vesicles.

2. The method of claim 1, for the preservation of lipid layers which are present in cells, at a temperature of 1 to 40° C.

3. The method of claim 2, wherein the cells are erythrocytes.

4. The method of claim 3, wherein the Dextran 1 is in a preservation solution.

5. The method of claim 4, wherein the preservation solution comprises: glucose; sodium chloride; adenine; and Dextran 1.

6. The method of claim 4, wherein the preservation solution comprises Dextran 1 in an amount of 0.5 to 10 g per 100 ml of the preservation solution.

7. (canceled)

8. The method of claim 4, wherein the preservation solution further comprises a buffer.

9. (canceled)

10. The method of claim 4, wherein the preservation solution comprises: citric acid monohydrate; sodium citrate dihydrate; sodium dihydrogen phosphate dihydrate; and dextrose monohydrate.

11. (canceled)

12. The method of claim 1, wherein the Dextran 1 is in a blood, erythrocyte and/or thrombocyte collection bag, to which blood, erythrocytes and/or thrombocytes can be added.

13. (canceled)

14. The method of claim 1, wherein Dextran 1 is used to supplement whole blood during haemodialysis.

15. (canceled)

16. (canceled)

17. The method of claim 1, wherein the micelles or vesicles encapsulate miRNA, mRNA or a pharmaceutical.

18. The method of claim 1, wherein the micelles or vesicles and Dextran 1 are in a suspension/solution, and wherein the concentration of Dextran 1 in the suspension/solution is 0.1 to 500 g/l.

19. (canceled)

20. An above 0° C. preservation solution for erythrocytes, wherein the solution comprises: glucose; sodium chloride; adenine; and Dextran 1.

21. (canceled)

22. (canceled)

23. (canceled)

24. A method of preserving lipid layers above 0° C., wherein the lipid layers are present in cells, micelles, or vesicles, the method comprising the steps of: a) administering Dextran 1 to a suspension of the cells, micelles or vesicles; and (b) storing the suspension for at least 1 day at 1 to 40° C., wherein the Dextran 1 is in a preservation solution and wherein the preservation solution comprises: glucose; sodium chloride; adenine; and Dextran 1.

25. (canceled)

26. The method of claim 3, wherein the cells are stored for at least 1 week.

27. The method of claim 1, wherein the cells are thrombocytes and wherein the cells are stored for at least 3 days.
